(19) United States
(12) Patent Application Publication
(10) Pub. No.: US 2005/0138119 A1
(43) Pub. Date: Jun. 23, 2005

(54) User-location service for ad hoc, peer-to-peer networks

(75) Inventor: Titos Saridakis, Espoo (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/745,961

(22) Filed: Dec. 23, 2003

(51) Int. Cl. G06F 7/00

(52) U.S. Cl. 709/204

(57) ABSTRACT

The present invention relates to a method, a terminal and a system for handling information about the presence of users in an ad hoc, peer-to-peer network. Mapping lists are stored in local repositories of terminals present in the network. The mapping list comprise mappings of user-addresses of the users to network addresses of the terminals present in the network. The mapping lists in the terminals present in the network are updated with respect to the terminals present in said network at a given instance.

### FIELD OF THE INVENTION

The present invention relates to a user-location service for ad hoc, peer-to-peer networks such as those that can be created over a short-range wireless medium like Bluetooth and WLAN. More specifically, the present invention relates to a method, a terminal and a system for handling information about user presence in an ad hoc, peer-to-peer network and for using such information to enable SIP deployment over such a network.

### BACKGROUND OF THE INVENTION

Ad hoc networks are those networks that are created with the spontaneous join or leave of their constituent nodes and they operate without relying on any network infrastructure. Until recent years ad hoc networks occurred rarely in practice and thus, they were of limited practical interest. Nowadays, the proliferation of personal mobile devices equipped with sort-range radio media like Bluetooth and WLAN, makes ad hoc networks of such peers a commonplace.

A number of different applications can benefit from such ad hoc networks. Examples are multi-player gaming over Bluetooth allowed by the N-Gage product from Nokia Corporation, phone call/conference, mobile chatting, user-content sharing (e.g. photo-albums, music top-10 lists, virtual community information, etc) presence information and more generally all those applications that involve person-to-person interactions. Such applications require information about the presence of users in an ad hoc network in order to establish connections among the terminals of those users and exchange application specific data. To obtain this presence information, a user-location service can be employed.

A user-location service provides information about the presence of users in a network. More specifically, a user-location service provides a mapping of a user address, usually expressed as a URI [IETF RFC2396] like a SIP address (e.g. sip:titos.saridakis@snokia.com) or an email address (e.g. mailto:titos.saridakis@nokia.com), to the network address where the specified user can be contacted. In many respects, a user-location service is similar to other directory services that provide information about the presence of machines, services or content in a network. Examples are the DNS [IETF RFC1034 and RFC1035] that maps machine names to IP addresses, the SLP [IETF RFC2608] that maps network services to IP addresses. These examples however are based on some centralized entity (the Domain Name Server and the SIP Registrar respectively), which makes them unsuitable for ad hoc, peer-to-peer networks.

An example of a distributed location protocol suitable for ad hoc, peer-to-peer networks is the Gnutella protocol. This protocol can be used to locate content (e.g. files) in ad hoc, peer-to-peer networks. A problem with the Gnutella protocol, as with many other distributed protocols, is that it generates a lot of overhead signalling. This is due to the use of broadcasting when locating the desired contents.

The design of a user-location service fit for ad hoc networks is a challenging task. The fundamental property of ad hoc networks is the absence of any guarantee regarding the presence of any node in the network, i.e. nodes may join and leave an ad hoc network at their own will. The absence of a generic way to locate users in ad hoc, peer-to-peer networks in prior-art leads the developer of applications for such networks to provide application-specific user-location functionality. This results in replication of the user-location functionality in every application that needs it, increases the probability of faulty software components, and complicates the maintenance of the software in the mobile terminal.

### SUMMARY OF THE INVENTION

The present invention provides a method of handling information about the presence of users in an ad hoc, peer-to-peer network, comprising: storing, in local repositories of terminals present in said network, mapping lists comprising mappings of user-addresses of said users to network addresses of the terminals present in the network; and updating said mapping lists in the terminals present in the network with respect to the terminals present in said network at a given instance. It is also directed to a terminal adapted for handling information about the presence of users in an ad hoc, peer-to-peer network, comprising: a local repository for storing a mapping list comprising mappings of user-addresses of said users to network addresses of terminals present in said network; and a repository manager for updating said mapping list with respect to the terminals present in said network at a given instance. The invention is further directed to a system adapted for handling information about the presence of users in an ad hoc, peer-to-peer network, comprising:
a first terminal comprising:
   a first local repository for storing a first mapping list comprising mappings of user-addresses of said users to network addresses of terminals present in said network; and
   a first repository manager for updating said first mapping list with respect to the terminals present in said network at a given instance; and
a second terminal comprising:
   a second local repository for storing a second mapping list comprising mappings of user-addresses of said users to network addresses of the terminals present in said network; and
   a second repository manager for updating said second mapping list with respect to the terminals present in said network at a given instance.

The present invention provides a distributed user-location service (DULS) fit for ad hoc, peer-to-peer networks. The DULS is based on local repositories in terminals present in an ad hoc, peer-to-peer network, which store mappings of user-addresses to network addresses of the terminals present in the network. The mapping lists are updated with respect to the terminals present in the network at a given instance.

The invention facilitates a generic handling of information regarding the presence of users in ad hoc, peer-to-peer networks, by storing mapping lists in local repositories in the terminals. Furthermore, the distribution of the repositories facilitates the joining and leaving of terminals in the network without the need to locate a central facility for user-location.

By storing the mappings of user-addresses to network addresses locally in the terminals, there is no need to broadcast any user location request in the network during user location as long as the mapping of the user has not changed since the last update of the mapping. Hence, the amount of signalling with respect to user location will be kept low according to the invention.

According to embodiments of the invention two protocols are provided that allow the local repositories to synchronize their contents in order to provide each peer with up-to-date user-location information. To synchronize the contents of local repositories of two terminals, is here to update the contents of the repository on one of the terminal so that is the same as the contents of the other terminal.

Furthermore, according to a further embodiment of the invention a novel way of deploying the entities specified in the SIP protocol among peers in an ad hoc network and combining the SIP Registrar with the DULS in order to allow the use of SIP in ad hoc, peer-to-peer networks. This makes the use of SIP [IETF RFC3261] possible in ad hoc networks, although the protocol has been specified with a central directory of user-location information in mind.

According to the embodiments of the invention, the join or leave at any time of any peer in an ad hoc network where DULS is deployed does not cause DULS to break down.

Furthermore, in embodiments of the invention the peers in the ad hoc network are personal mobile devices (e.g. mobile phones) with limited autonomy. Given that the frequency and the payload of communications have a direct impact on the device autonomy, the DULS synchronization protocols should in such embodiments preferably keep both these parameters as low as possible for a given context of use.

The combination of the DULS according to the invention with the SIP Registrar and the deployment of SIP entities over an ad hoc network according to the embodiment of the invention conform to the SIP specifications.

In a first embodiment of the invention, one peer (a peer is an instance of the DULS running on a mobile terminal) is used as a coordinating peer. The rule according to which it is determined which peer is the coordinating peer, should be possible to apply individually within each peer and result in the identification of the same peer by the peers in the network. For example, the peer with the smallest network address in an ad hoc network could be determined to be used as a coordinating peer. The coordinating terminal has in its local repository a view of the network composition and whenever this view is modified due to joins and leaves of peers, it multicasts the updated view to all peers whose addresses are present in the updated view. The coordinating peer may itself leave the ad hoc network. This will be detected by the remaining peers and the one determined to be the new coordinating peer according to the common rule, e.g. the rule pointing out the peer with the smallest network address, will take over the role of the coordinating peer.

The fact that DULS synchronizations are triggered by networks events (i.e. joins and leaves of peers) makes the first embodiment of the invention suitable for applications that are interested in monitoring such network events. For example, in multiparty gaming sessions, the leave of a peer from the network causes changes in the application data (e.g. the character controlled by the departed peer is removed from the game). Another example is mobile presence applications, where the application needs to be aware of the join or leave of a peer in order to provide consistent presence information to the user.

In a second embodiment of the invention, a fully distributed scheme for updating the contents of local repositories is followed. Each peer relies on the user-location information that is available in its local repository. If the information in the local repository is invalid (e.g. because the indicated peer has left the network) or the local repository does not have any information regarding a specified user, then it contacts other peers in the ad hoc network requesting to resolve the specified user address. Eventually, if the specified user is present on one of the peers in the ad hoc network then the requesting peer will receive this information.

The fact that a local repository updates its contents triggered by application requests to resolve user addresses (as opposed to a reaction to network events) makes the second embodiment of the invention suitable for applications that do not require an up-to-date view of user presence in the ad hoc network at all times. For example, in mobile instant messaging the resolution of a user address to a network address is needed only once an instant message is completed and sent. While the message is being typed, there is no need to react to network events

In a further embodiment of the invention the Session Initiation Protocol, SIP, is applied for handling sessions in an ad hoc, peer-to-peer network. The peers (a peer is an instance of the DULS running on a mobile terminal) in an ad hoc network are each arranged with a SIP User Agent (UA), a local SIP Proxy, a local SIP Registrar and an instance of the DULS. The SIP UA handles SIP communication, i.e. it creates SIP requests/responses to be sent to other peers and parses SIP requests/responses sent by other peers. The SIP Registrar receives requests from the SIP UA, via the local SIP Proxy, to resolve a SIP address to the network address where the specified user is located. The DULS instance contains the mapping of SIP addresses to network addresses that are required by the local SIP Registrar.

The use of the DULS to provide SIP address resolution to the SIP Registrar enables the deployment of SIP on ad hoc networks without having to rely on a single instance of the SIP Registrar as it is the practice in the SIP deployment on cellular networks. The SIP UA knows how to contact the SIP Registrar that exists on the same peer and the synchronization or the update of the DULS instance on a peer allows the SIP Registrar to resolve any SIP address, provided that the corresponding user is present in the ad hoc network.

Since there are no restrictions in the SIP specification whether the SIP Proxy or the SIP Registrar needs to be unique and no restrictions regarding the behaviour of the location service used by the SIP Registrar, the further embodiment fully conforms to the SIP specification.

### BRIEF DESCRIPTION OF THE DRAWINGS

Exemplifying embodiments of the present invention will be described in the following with reference to the accompanying drawings, in which:

FIG. 1 shows a flow chart of a first embodiment of a method according to the invention;

FIG. 2 shows a flow chart of a second embodiment of a method according to the invention;

FIG. 3 shows a schematic view of a prior art system; and

FIG. 4 shows a schematic view of an embodiment of a system according to the invention, the system comprising terminals according to an embodiment of the invention.

### DETAILED DESCRIPTION OF THE INVENTION

The following describes in more detail two embodiments of the method according to the invention and the deployment of SIP entities on mobile terminals, which allows the use of SIP in ad hoc, peer-to-peer networks.

Both embodiments of the method according to the invention are performed in a network of peers connected in an ad hoc way, i.e. peers can join and leave the network without any prior notification to other network members. Furthermore, according to both embodiments, peers are personal mobile devices operated by a human. The human may have multiple user addresses and may operate multiple devices. This implies that the same user address can be mapped to multiple network addresses and that multiple user addresses can be mapped to the same network address. Another general assumption is that the network protocol has device discovery capabilities (e.g. the Bluetooth service discovery protocol also known as SDP). Finally, the two embodiments of the method according to the invention are advantageously, but not necessarily, implemented in networks having multicasting capabilities.

The first embodiment of the invention describes a distributed synchronization protocol for DULS instances in an-ad hoc, peer-to-peer network. In addition to the above general assumptions, according to the first embodiment, the set of network addresses is totally ordered (i.e. for any two network addresses X and Y, either X≦Y or Y≦X). This assumption implies that there is a single device with “smallest” address in the network, which will play the role of the coordinating peer. It is to be noted that this assumption is hardly restrictive since it is satisfied by Bluetooth MAC addresses, 802.11 (WLAN) MAC addresses and IP addresses. This assumption is there to ensure that a coordinating peer can be identified independently by all peers in the network. Of course any coordinating rule identification rule may be used, as long as the identification can be done individually by the peers and the same peer is identified by the peers in the network.

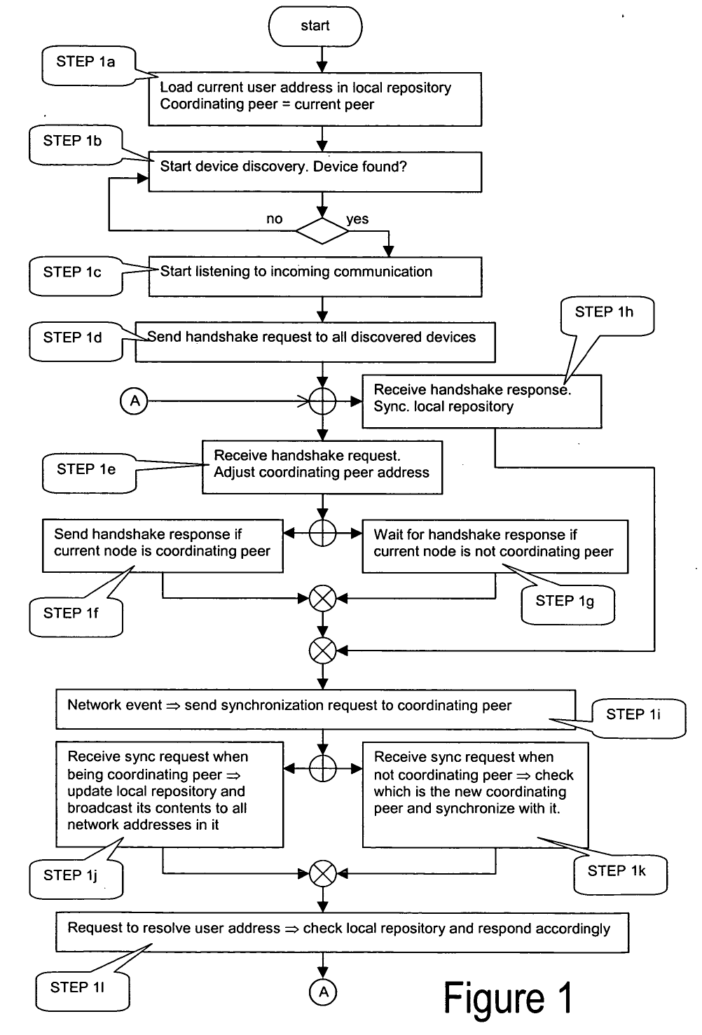

FIG. 1 provides the flowchart that summarizes STEPS 1a-1l of the first embodiment of this invention that describes the distributed synchronization protocol for DULS.

The distributed synchronization protocol for DULS instances according to the first embodiment of the method of this invention prescribes the deployment of one DULS instance per peer in the ad hoc network. A DULS instance includes a local Repository that contains mappings of user addresses to network addresses plus the logic captured in the sequence of interactions, which allows the local Repositories to keep their contents synchronized. This sequence of DULS interactions is described in the following steps (STEP 1a-STEP 1l).

STEP 1a: when a DULS instance is activated (e.g. when the Bluetooth transceiver on device is switched on), it sets the address of the coordinating peer to be the network address of the local device. Then, it loads to the local Repository the entries that contain the mappings of the current user addresses (it is possible for a user to have more than one user address) to the current network address of the device. If MAC addresses are used as network addresses, the current network address of a device is always the same; if IP addresses are used as network addresses, the current network address of a device may change every time the device connects to a different network.

STEP 1b: the DULS instance employs the device discovery capabilities of the network protocol in order to find other devices in the network. STEP 1b is repeated periodically until other devices are discovered.

STEP 1c: the DULS instance starts “listening” for requests and responses that it will send according to the following steps.

STEP 1d: the DULS instance sends to ALL devices discovered in STEP 1c a handshake request (multicast can be used if available). The handshake request includes the contents of the local Repository (i.e. the mappings of the user addresses to the current network address of the device).

STEP 1e: when a DULS instance receives a handshake request, it parses its contents, extracts the network address from the mappings it contains, and compares that network address to the network address of the local device. If the network address extracted from the handshake request is smaller than the current address of the coordinating peer, then the address of the coordinating peer is set to be the address extracted from the handshake request.

STEP 1f: If, prior to the reception of the handshake request, the current device was the coordinating peer then the DULS instance responds to the handshake request by sending a handshake response with the contents of its local Repository to ALL network addresses present in the local Repository (multicast can be used if available).

STEP 1g: If, prior to the reception of the handshake request, the current device was NOT the coordinating peer then the DULS instance does not respond to the handshake request. Rather, it waits to receive the handshake response sent by the coordinating peer. If such handshake response is NOT received within a predefined timeout period, then the device with the second smallest network address assumes the role of the coordinating peer and sends the handshake response to ALL network addresses present in the local Repository. If within a second timeout period no handshake response is sent, then the device with the third smallest network address assumes the role of the coordinating peer and sends the handshake response. The same scheme is followed until a handshake response is sent.

STEP 1h: when a DULS instance receives a handshake response, it parses its contents, extracts the network addresses from the mappings it contains, and compares those network address to the network address of the local device. If the local network address is smaller than all network addresses in the handshake response then this device assumes the role of the coordinating peer for subsequent interactions. In any case, it synchronizes the local Repository with the contents of the handshake response.

STEP 1i: if a DULS instance receives indication (e.g. from the application or from the network layer) that a given network address is not responding then it sends to the coordinating peer a synchronize request including the network address that is not responding. If the network address that is not responding is that of the coordinating peer then the DULS sends a synchronize request to ALL network addresses present in the local Repository.

STEP 1j: if the DULS instance of the coordinating peer receives a synchronize request, it removes the non-responding network address (and the associated user addresses) from its local Repository and sends to ALL remaining network addresses in the local Repository a synchronize response with the contents of the local Repository (multicast can be used if available).

STEP 1k: if a DULS instance receives a synchronize request although it is not the coordinating peer (this means that the coordinating peer is not responding) then it removes the indicated network address from the local Repository and it checks whether the network address of the present device is the smallest remaining one. If it is, then this DULS assumes the coordinating peer role and sends to ALL network addresses in its local Repository a synchronize response with the contents of the local Repository. If it is NOT, then it waits for a predefined timeout period to receive a synchronize response from the new coordinating peer, following the same scheme as in STEP 1g.

STEP 1l: if a DULS instance receives from the application layer a request to resolve a user address, it looks it up in the local Repository. If the user address is found in the local Repository then the corresponding network address(es) are returned. Otherwise, the user address resolution fails.

The advantage of the distributed synchronization protocol described above is that it instantly replies to the application-layer requests for user address resolution. This is possible because the contents of local Repositories are synchronized, reacting to network events (i.e. join and leave of peers). If the frequency of network events is not high, which is true for ad hoc network that have relatively stable membership during their lifetime, this protocol combines low communication overhead (due to small number of network events) with minimum response time to application-layer requests.

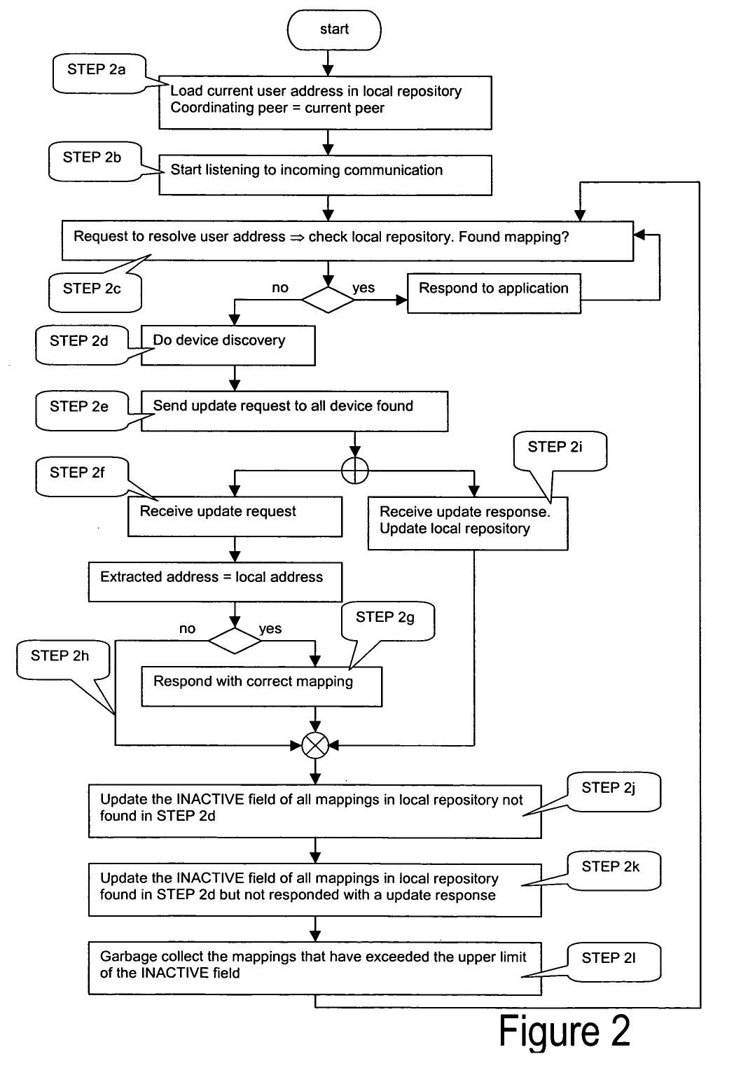

FIG. 2 provides the flowchart that summarizes STEPS 2a-2l of the second embodiment of this invention that describes the lazy update protocol for DULS.

The second embodiment of the invention describes a lazy update protocol for DULS instances in an ad hoc, peer-to-peer network and it is only based on the general assumptions presented in the beginning of this section.

The lazy update protocol for DULS instances described in the second embodiment of this invention prescribes the deployment of one DULS instance per peer in the ad hoc network. A DULS instance includes a local Repository that contains mappings of user addresses to network addresses plus the logic captured in the sequence of interactions, which allows the local Repositories to keep their contents up-to-date with the current network view (i.e. the set of peers present in the network). This sequence of DULS interactions is described in the following steps (STEP 2a-STEP 2l).

STEP 2a: same as STEP 1a.

STEP 2b: same as STEP 1c.

STEP 2c: when the DULS instance receives from the application layer a request to resolve a user address, it checks the local Repository. If the user address is in the local Repository then the DULS instance returns the corresponding network address(es) to the application layer. If the user address is NOT in the local Repository, then the DULS instance proceeds to STEP 2d.

STEP 2d: the DULS instance employs the device discovery capabilities of the network protocol to find other devices that are currently in the ad hoc network. Unlike STEP 1b, the use of the device discovery capabilities of the network protocol is not periodic.

STEP 2e: the DULS instance sends to ALL devices discovered in STEP 2d an update request that contains the user address that needs to be resolved (multicast can be used if available). If the packet-size of a message send over the network allows it, the update request may also contain fragments of the local Repository, e.g. the most up-to-date or the most recently acquired. The DULS instance waits for replies to those update request for a predefined timeout period.

STEP 2f: when a DULS instance receives an update request, it parses it and extracts the user address that needs to be resolved. Optionally, if there is additional content in the update request (i.e. fragments of the requesting DULS's Repository) the local DULS instance may parse it and use it, entirely or selectively, to update the local Repository.

STEP 2g: if the requested user address extracted in STEP 2f is one of those initially loaded to the local Repository in STEP 2a, the DULS instance MUST send back to the requesting DULS instance an update response. The update response contains the mapping of the user address extracted from the update request to the network address of the present device. If the packet-size of a message send over the network allows it, the update response may also have a second part that contains fragments of the local Repository, e.g. the most up-to-date or the most recently acquired.

STEP 2h: if the requested user address extracted in STEP 2f is NOT one of those initially loaded to the local Repository in STEP 2a, the DULS instance DOES NOT have to reply with an update response. Optionally, the DULS instance may reply with an update response that is composed of an empty first part and a second part that contains fragments of the local Repository, e.g. the most up-to-date or the most recently acquired. If the user address extracted in STEP 2f is present in the local Repository, then the corresponding mapping may be present in the second part of the update response.

STEP 2i: when a DULS instance receives an update response, it parses its first part and extracts the mapping of user address to network address. If this mapping is not empty, then the extracted user address is present at the extracted network address. The corresponding mapping is placed in the local Repository and with the INACTIVE counter set to zero. The network address is returned to the application layer as a response to the request for user address resolution. If the update response has a second part (this is optional), then the DULS instance MUST parse it and use its contents to update the local Repository. If a mapping of the user address that needs to be resolved is found in the second part of the update response, then it is returned to the application layer as a response to the request for user address resolution.

STEP 2j: for all the mappings in the local Repository with network addresses that were not returned by the device discovery engaged in STEP 2d, the INACTIVE counter is increased by one.

STEP 2k: at the end of the timeout period mentioned in STEP 2e, the DULS instance increases by one the INACTIVE counter of those mappings in the local Repository which have a network address returned by the device discovery in STEP 2d, but they did not respond with the same user address as it is found in the mapping.

STEP 2l: To ensure a bounded size for the local Repository, when the upper limit is reached then the mappings with the highest INACTIVE counter are deleted.

The advantage of the lazy update protocol described above is that it produces network traffic only when this is necessary. This is possible because the protocol is activated only upon application-layer request the resolution of a user address (as opposed to reactions to network events, which was the case of the first embodiment of the invention). If the frequency of network events is high, this protocol provides means for user address resolution that is very economical with respect to the number of network interactions and hence the energy saving factor.

A further embodiment of this invention refers to the use of DULS (with the distributed synchronization or the lazy update protocol) to enable the deployment of SIP entities in an ad hoc, peer-to-peer network. In brief, SIP [IETF RFC 3261] is a protocol that describes, given a SIP identifier (a user address in a SIP-specific format), how to find the device where the specified user can be reached and sent an invitation for a session. The SIP specification describes the following SIP entities and relations among them.

SIP User agents (UAs) create and send, but also receive and process, SIP requests and responses on behalf of users. The recipient of SIP requests and responses is a SIP address.

A SIP Registrar is an entity that provides a directory service for SIP UAs. SIP UAs are configured with the network address of a Registrar to which they send REGISTER requests in order register the network address where they are located, and which they contact to resolve a SIP address to the network address where a SIP request must be sent.

A SIP Proxy is a routing element in a virtual network of SIP UAs and Registrars. SIP UAs send requests and responses through SIP Proxies. SIP Proxies are intermediary points responsible for receiving SIP requests and forwarding them closer to their intended recipient. A SIP Proxy interprets and, if necessary, rewrites specific parts of a request before forwarding it.

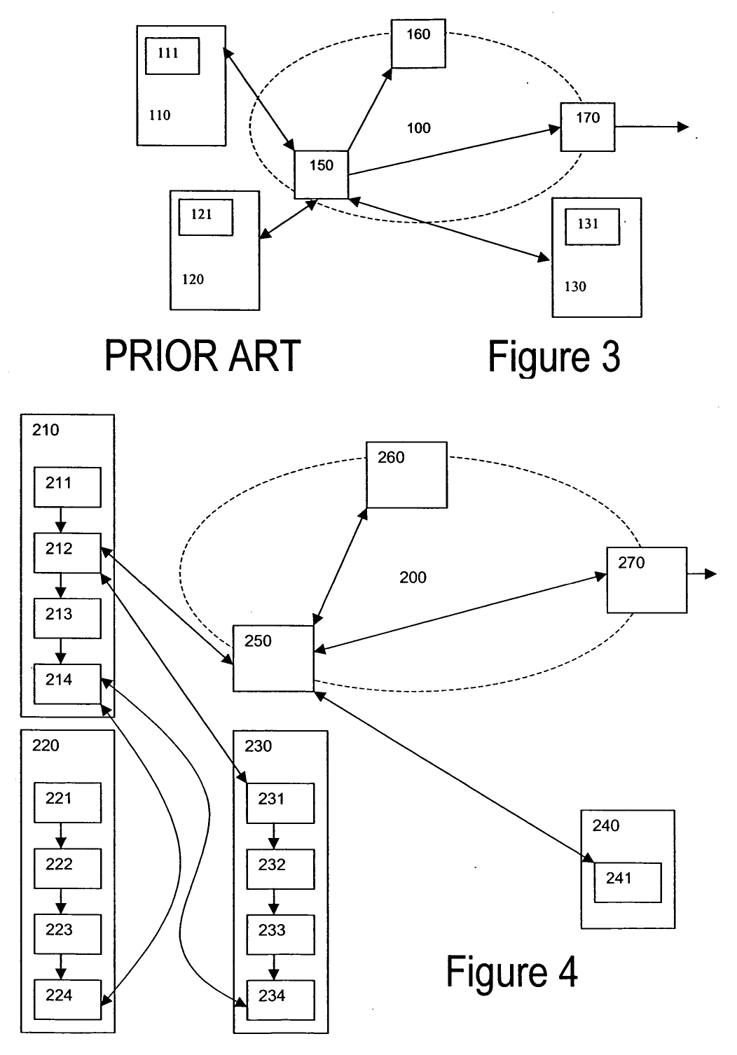

The current practice in deploying SIP entities on mobile phones is optimized for SIP usage over the cellular network, but it is not adequate for SIP usage over short-range wireless media (e.g. Bluetooth and WLAN) over which ad hoc, peer-to-peer network can be created. In current practice, the only SIP entity on the mobile phone is a SIP UA, which is configured to send all SIP requests to a SIP Proxy that resides on the cellular network. A SIP Registrar also exists in every cellular network owned by a different operator. FIG. 3 illustrates graphically the current practice regarding SIP deployment on mobile phones.

In FIG. 3, each of the mobile phones 110, 120, and 130 contains only a SIP UA, respectively 111, 121, and 131. Each SIP UA is configured with the address of the SIP Proxy 150 that resides on the operator's network 100. When SIP UA 111 wants to register, it sends to Proxy 150 a REGISTER request, which forwards it to the SIP Registrar 160. When SIP UA 121 wants to send a SIP request (e.g. an INVITE) to SIP UA 131, it sends it to Proxy 150, which forwards it to SIP UA 131. When SIP UA 111 wants to send a SIP request to a SIP UA that resides on a mobile phone in another operator's network, then it sends it to Proxy 150, which realizes that the recipient resides in another network and forwards it to Proxy 170. Proxy 170 is responsible for forwarding request to other networks (it acts like a network router).

This deployment of SIP entities is not suitable for SIP usage in ad hoc, peer-to-peer networks because it places SIP Registrars and Proxies on a stable infrastructure (the cellular network). The further embodiment this invention described in the following relates to a novel deployment of SIP entities, which allows SIP usage in ad hoc, peer-to-peer networks but also integrates with the SIP entities deployed on the cellular network as compelled by the current practice.

By definition, each peer must have equivalent capabilities with any other peer in an ad hoc, peer-to-peer network. In addition, no other entities except peers can be assumed to exist in an ad hoc, peer-to-peer network. Hence, every peer must contain all three prominent SIP entities, i.e. the UA, the Registrar and the Proxy.

Rather than being configured with the SIP Proxy residing on the cellular network, a SIP UA is configured to contact the local SIP Proxy residing on the same terminal. The local Proxy is responsible for forwarding REGISTER requests both to the local Registrar and to the SIP Proxy residing on the cellular network, which further forwards them to the SIP Registrar residing on the cellular network. Finally, the local Registrar uses the DULS to store and to obtain mappings of SIP addresses to network addresses. Hence, the local Registrar is the application-layer for DULS.

When the SIP UA sends a SIP request, it is received by the local Proxy, which in turn requests from the local Registrar to resolve the SIP address. The local Registrar uses DULS to find the network address that corresponds to the given SIP address. If the SIP address is resolved, the resulting network address is returned to the local Proxy, which uses it to forward the initial SIP request. If the SIP address is not resolved by the local Registrar (i.e. the intended SIP recipient is not accessible over the ad hoc, peer-to-peer network), the local Proxy forwards the request for SIP address resolution to the SIP Proxy residing on the cellular network. In turn, the SIP Proxy on the cellular network attempts to resolve the SIP address using the SIP Registrar residing on the cellular network, and the whole SIP mechanism works like in current practice.

FIG. 4 illustrates graphically the suggested deployment of SIP entities on the mobile phones and the way they integrate with the SIP infrastructure compelled by the current practice. The SIP entities on the cellular network 200 are the same as in FIG. 3. The entity 250 is the SIP Proxy on the cellular network that receives all SIP requests sent to mobile phone over the cellular network. The entity 260 is the SIP Registrar residing on the cellular network. The entity 270 is the SIP Proxy that forwards SIP requests to other operators' networks. Each of the mobile phones 210, 220, and 230 follows the deployment of the SIP entities suggested in this invention. Each has a SIP UA (211, 221, and 231 respectively), a local SIP Proxy (212, 222, and 232 respectively), a local SIP Registrar (213, 223, and 233 respectively) and a DULS instance (214, 224, and 234 respectively). The mobile phone 240 follows the current practice in the deployment of SIP entities; it has only a SIP UA, 241.

Following one of the two protocols described in the two embodiments of this invention, the DULS instances on the mobile phones provide SIP address resolution to the local SIP Registrar. So, when the SIP UA 211 sends a SIP request to the SIP UA 231, the following sequence of interaction happens. First, the local Proxy 212 receives the SIP request, extracts the SIP address of the intended recipient and tries to resolve it with the local Registrar 213, which, in turn, retrieves the correct mapping from the DULS instance 214. Having resolved the SIP address of the intended recipient, the local Proxy 212 forwards over the ad hoc network (e.g. a Bluetooth piconet) the SIP request to the SIP UA 231.

This deployment works well with the current deployment of SIP entities over the cellular network, as demonstrated below. When the SIP UA 211 sends a SIP request to the SIP UA 241, the local Proxy 212 receives it, extracts the SIP address of the intended recipient and tries to resolve it with the local Registrar 213, which, in turn, attempts to retrieve the correct mapping from the DULS instance 214. However, the SIP address of the SIP UA 241 cannot be resolved to a network address of the ad hoc network because the mobile phone 240 does not have the SIP entities that are prescribed by this invention. Hence, the local Registrar 213 fails to resolve the SIP address of the SIP UA 241. Subsequently, the local Proxy 212 forwards the initial SIP request to the SIP Proxy 250 on the cellular network. This SIP Proxy 250 extracts the SIP address of the intended recipient from the SIP requests and attempts to resolve it with the SIP Registrar 260 that resides on the network. The SIP Registrar 260 returns the network address of the SIP UA 241 and returns it to the SIP Proxy 250, which forwards the initial SIP request to the right mobile phone where it reaches the SIP UA 241.

1. A method of handling information about the presence of users in an ad hoc, peer-to-peer network, comprising:
storing, in local repositories of terminals present in said network, mapping lists comprising mappings of user-addresses of said users to network addresses of the terminals present in the network; and
updating said mapping lists in the terminals present in the network with respect to the terminals present in said network at a given instance.

2. The method of claim 1, wherein the updating is performed coordinated between the terminals present in said network in response to terminals joining said network and terminals leaving said network.

3. The method of claim 2, wherein one terminal of the terminals present in said network is a coordinating terminal, and wherein the updating comprises:
receiving, in said coordinating terminal, indications of terminals joining said network and of terminals leaving said network;
updating the mapping list in the local repository of said coordinating terminal with respect to the terminals joining said network and the terminals leaving said network;
sending, from said coordinating terminal to the terminals present in said network, the updates of the mapping list in the local repository of said coordinating terminal; and
updating the mapping lists in the local repositories in the terminals present in said network in accordance with the updates of the mapping list in the local repository of said coordinating terminal.

4. The method of claim 1, wherein said updating is done individually in a first terminal of the terminals present in said network in response to the invalidity in the mapping list in said first terminal of the mapping of the user-address to the network address of a second terminal.

5. The method of claim 4, wherein said updating comprises:
requesting, in response to the invalidity in the mapping list in said first terminal of the mapping of the user-address to the network address said second terminal, an update with respect to the mapping of the user-address to the network address of said second terminal from the terminals present in said network;
receiving in said first terminal said update with respect to the mapping of the user-address to the network address of said second terminal; and
updating the mapping list in said first terminal, in accordance with the received update.

6. The method of claim 1, wherein said mappings of user-addresses to network addresses in said mapping lists are mappings of SIP-addresses to network addresses.

7. A terminal adapted for handling information about the presence of users in an ad hoc, peer-to-peer network, comprising:
a local repository for storing a mapping list comprising mappings of user-addresses of said users to network addresses of terminals present in said network; and
a repository manager for updating said mapping list with respect to the terminals present in said network at a given instance.

8. The terminal of claim 7, wherein said repository manager is arranged to update said mapping list in response to terminals joining said network and terminal leaving said network.

9. The terminal of claim 8, further comprising:
a receiver for receiving indications of terminals joining said network and of terminals leaving said network; and
a sender for sending, from the terminal to said terminals present in said network, the updates of the mapping list.

10. The terminal of claim 7, further comprising:
a receiver for receiving updates of the mapping list of a terminal present in said network,
wherein said repository manager is arranged to update said mapping list in response to received updates.

11. The terminal of claim 7, wherein said repository manager is arranged to update said mapping list in response to the invalidity in said mapping list of the mapping of a user-address to a network address.

12. The terminal of claim 11, further comprising:
a sender for sending, in response to the invalidity in said mapping list of the mapping of the user-address to the network address, a request for an update with respect to the mapping of the user-address to the network address; and
a receiver for receiving said update with respect to the mapping of the user-address to the network address of said second terminal,
wherein said repository manager is arranged to update the mapping list, in accordance with the received update.

13. The terminal of claim 7, wherein said user-addresses are SIP addresses, further comprising:
a SIP User Agent for creating SIP requests including SIP addresses and for sending them to a local SIP Proxy;
said local SIP Proxy for receiving SIP requests from said SIP User Agent, for extracting said SIP addresses, for requesting and receiving the mapping of SIP addresses to network addresses from a local SIP Registrar, and for forwarding said SIP requests to the terminals having said network addresses; and
said local SIP Registrar for resolving the mapping of SIP addresses to network addresses by means of lookup in said local repository in the terminal.

14. A system adapted for handling information about the presence of users in an ad hoc, peer-to-peer network, comprising:
a first terminal comprising:
a first local repository for storing a first mapping list comprising mappings of user-addresses of said users to network addresses of terminals present in said network; and
a first repository manager for updating said first mapping list with respect to the terminals present in said network at a given instance; and
a second terminal comprising:
a second local repository for storing a second mapping list comprising mappings of user-addresses of said users to network addresses of the terminals present in said network; and
a second repository manager for updating said second mapping list with respect to the terminals present in said network at a given instance.

15. The system of claim 14, wherein said first repository manager is arranged to update said mapping list in response to terminals joining said network and terminal leaving said network, and said first terminal further comprises:
a first receiver for receiving indications of terminals joining said network and of terminals leaving said network; and
a first sender for sending, from the first terminal to the terminals present in said network, the updates of the mapping list, and
wherein said second terminal further comprises:
a second receiver for receiving said updates, and
said second repository manager is arranged to update the second local repository with respect to received updates.

16. The system of claim 14, wherein said first terminal further comprises:
a first sender for sending, in response to the invalidity in said mapping list of the mapping of the user-address to the network address of the second terminal, a request for an update with respect to the mapping of the user-address to the network address of the second terminal to the terminals present in the network; and
a first receiver for receiving said update with respect to the mapping of the user-address to the network address of said second terminal, and
said first repository manager is arranged to update the mapping list, in accordance with the received update, and
wherein said second terminal further comprises:
a second receiver for receiving said request; and
a second sender for sending said update.

17. The system of claim 14, wherein said user-addresses are SIP addresses, and said first terminal further comprising:
a first SIP User Agent for creating SIP requests including SIP addresses and for sending them to a first local SIP Proxy;
said first local SIP Proxy for receiving SIP requests from said first SIP User Agent, for extracting said SIP addresses, for requesting and receiving the mapping of SIP addresses to network addresses from a first local SIP Registrar, and for forwarding said SIP requests to the terminals having said network addresses; and
said first local SIP Registrar for resolving the mapping of SIP addresses to network addresses by means of lookup in said first local repository in the first terminal,
and said second terminal further comprising:
a second SIP User Agent for creating SIP requests including SIP addresses and for sending them to a second local SIP Proxy;
said second local SIP Proxy for receiving SIP requests from said second SIP User Agent, for extracting said SIP addresses, for requesting and receiving the mapping of SIP addresses to network addresses from a second local SIP Registrar, and for forwarding said SIP requests to the terminals having said network addresses; and
said second local SIP Registrar for resolving the mapping of SIP addresses to network addresses by means of lookup in said second local repository in the second terminal.
